(19) United States
(12) Patent Application Publication
(10) Pub. No.: US 2012/0208711 A1
(43) Pub. Date: Aug. 16, 2012

(54) Method for Analysis of DNA Methylation Profiles of Cell-Free Circulating DNA in Bodily Fluids

(75) Inventors: Rene Cortese, Toronto (CA); Arturas Petronis, Toronto (CA)

(73) Assignee: CENTRE FOR ADDICTION AND MENTAL HEALTH, TORONTO (CA)

(21) Appl. No.: 13/498,966

(22) PCT Filed: Oct. 1, 2010
(86) PCT No.: PCT/CA10/01558

§ 371 Date: May 2, 2012

Related U.S. Application Data
(60) Provisional application No. 61/248,137, filed on Oct. 2, 2009.

(51) Int. Cl. C40B 20/00

(52) U.S. Cl. 506/2

(57) ABSTRACT

The invention can be summarized as follows. There is provided a method for analyzing DNA methylation profiles of cell-free DNA in body fluids by enriching a methylated or unmethylated fraction of DNA from cell-free DNA and subjecting the enriched DNA to microarray based methylome profiling and bioinformatics data analysis.

### FIELD OF INVENTION

The present invention relates to methods and systems for epigenetic profiling. More specifically, the present invention relates to methods and systems for large-scale DNA methylation profiling of circulating cell-free DNA in bodily fluids.

### BACKGROUND OF THE INVENTION

DNA methylation is the biochemical addition of a methyl group (—CH₃) to a nucleotide molecule. In mammalian genomes, this addition occurs predominantly to cytosines, especially in the context of a cytosine-guanosine (CpG) dinucleotides. In healthy cells, the modified methyl cytosine (mC) is present at a 2%-5% level of all cytosines [1]. CpG sites are present much less significantly than expected (5-10 fold) from the overall base composition of the DNA and unevenly distributed throughout the genome. While the vast majority of the genome is CpG poor, about 1% consists of CpG rich areas, typically related to the transcription start sites of the genes. These CpG regions are referred as “CpG islands” and are mainly unmethylated when located nearby the transcription start sites of expressed genes, in clear contrast to the mainly, but not exclusively, methylated rest of the genome [2, 3]. During cell division, DNA methylation profiles are copied after DNA synthesis, resulting in heritable changes in chromatin structure [4].

DNA methylation represents a chemically and biologically stable epigenetic modification and potential tumor/disease-specific marker that can be readily detected and quantified, independent of the level of gene expression. DNA methylation biomarkers have several advantages compared to other genetic or epigenetic aberrations. For example, changes in DNA methylation profiles are detected very early in tumor progression, enabling its application as early detection biomarkers [5]. Once established, DNA methylation patterns will generally not be lost and are often enhanced during disease progression [6].

Cell-free DNA circulates in both, healthy and diseased individuals. It has been demonstrated that circulating tumor DNA is not confined to any specific cancer type, but appears to be a common finding across different malignancies [7]. The free circulating DNA concentration in plasma has been estimated at 14-18 ng/ml in control subjects and 180-318 ng/ml in patients with neoplasias [8]. Apoptotic and necrotic cell death contribute to cell-free circulating DNA in bodily fluids [9]. For example, significantly increased circulating DNA levels have been observed in plasma of prostate cancer patients and other prostate diseases, such as Benign Prostate Hyperplasia and Prostatits [10-12]. In addition, circulating tumor DNA is present in fluids originating from the organs where the primary tumor occurs. Thus, breast cancer detection can be achieved in ductal lavages [13]; colorectal cancer detection in stool [14]; lung cancer detection in sputum [15] and prostate cancer detection in urine or ejaculate [16]. Minimal DNA amounts extracted from the patient's body fluids can be amplified and precisely quantified, placing DNA-based approaches amongst the most promising methods for cancer screening in terms of specificity and sensitivity [17]. Nevertheless, tumor circulating DNA represents only a small fraction of the total circulating DNA, sometimes less than 0.01% [18]. Therefore, any method for detecting changes in tumor circulating DNA must be sensitive, specific and mimimize false results derived from amplification of non-tumor circulating DNA.

There is a need in the art for novel methods of identifing DNA-methylation-based biomarkers that have application in early diagnosis of disease. Further, there is a need in the art to identify novel genetic markers having altered DNA methylation profiles in disease. There is also a need in the art for novel methods of identifying markers having altered DNA methylation profiles in cell-free circulating DNA in blood plasma and other bodily fluids, the markers capable of being employed in non-invasive methods for early diagnosis of malignant diseases.

There is also a need in the art for novel methods of analyzing DNA methylation profiles of cell-free DNA. Moreover, there is a need in the art for profiling DNA-methylation-based biomarkers from circulating tumor-derived DNA contaminated with normal genomic DNA from the same subject.

### SUMMARY OF THE INVENTION

The present invention relates to methods and systems for epigenetic profiling. More specifically, the present invention relates to methods and systems for large-scale DNA methylation profiling of circulating cell-free DNA in bodily fluids.

According to the present invention there is provided a method for analyzing large-scale DNA methylation profiles of cell-free DNA in bodily fluids comprising the steps of:

a) obtaining a body fluid from a subject that comprises cell-free DNA;

b) amplifying a methylated fraction of DNA or a unmethylated fraction of DNA from said cell-free DNA to produce amplified cell-free DNA that is between about 0.1-5 Kb in size;

c) labeling said amplified cell-free DNA with a first label to produce labeled amplified, cell-free DNA;

d) amplifying a DNA pool isolated from peripheral blood leukocytes from several healthy individuals mechanically fragmented to about 0.1-5 kbp in size to produce amplified, pooled DNA;

e) labeling said amplified, pooled DNA with a second label which is different from said first label to produce labeled, amplified, pooled DNA;

f) combining labeled, amplified, pooled DNA with labeled amplified cell-free DNA and subjecting the combined sample to microarray hybridization and analysis to analyze DNA methylation profiles in cell-free DNA.

Also according to the present invention there is provided a method as described above, wherein the body fluid is blood.

The present invention also contemplates a method as described above, wherein the body fluid is plasma.

The present invention also provides a method as described above, wherein the body fluid comprises cells and the method further comprises a step of separating cells from said cell-free DNA.

Also provided is a method as described above, wherein the cell-free DNA comprises DNA from diseased cells or tissue.

The present invention also provides a method as described above, wherein the diseased cells or tissue comprise cancer or tumor cells.

Also provided is a method as described above, wherein the methylated fraction of cell-free DNA is amplified and said DNA is between 0.1-1.5 kbp in size.

The present invention also contemplates a method as described above, wherein the first label is Cy3 and the second label is Cy 5 or vice-versa.

Also provided is a method as described above, wherein the pooled DNA sample comprises pooled blood samples.

The present invention also contemplates a method as described above, wherein the pooled DNA sample is sonicated to comprise DNA fragments between about 0.1-5 kbp in size.

Also provided is a method as described above, wherein the body fluid is blood and the pooled DNA sample comprises blood pooled from healthy subjects of varying ages, genders and ethnicities.

The present invention also contemplates a method as described above, wherein the amplified cell-free DNA and the amplified, pooled sample of DNA are each between about 400 to 1,500 base pairs in size.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 shows an aspect of an embodiment of the method of the present invention for DNA methylation detection in plasma samples. PCR products are obtained only in templates from fragmented DNA either containing methylated CpG positions (enriched methylated fraction) or lacking targets for restriction enzymes. DNA samples isolated from plasma or body fluids comprise fragmented DNA originating from apoptotic/necrotic tumor cells (right) and larger size genomic DNA originating from circulating cells (i.e. lymphocytes) (left). First, universal adaptors (rectangular boxes) are ligated to the end of the DNA molecules. Next, samples are digested with DNA methylation sensitive restriction enzymes. These enzymes will cut only at unmethylated CpG positions (white lollipops) but not in methylated CpG positions (black lollipops). Digested DNA is then amplified using primers that bind to the universal adaptors (half arrows). During the PCR reaction, DNA polymerase extends primers (dashed lines) according to its processivity and the reaction conditions.

FIG. 2 shows results of preferential amplification of circulating cell-free DNA. Amplification of DNA isolated from plasma samples. Lines 1-4, amplification using plasma DNA samples. Lines 5-10, control amplifications using a 1:5 mixture of degraded and genomic (intact) human DNA (#5), artificially degraded DNA (#6), genomic (intact) human DNA (#7), no T4 polymerase during blunting (#8), no T4 ligase during adaptor ligation (#9), no template control for PCR (#10). Electrophoresis conditions: Molecular weight marker: 100 bp Ladder (Fermentas). 10 μl of PCR product were loaded in a 1% agarose gel. Gels were run at 100 mV for 40 minutes in 1×TBE buffer.

FIGS. 3 A, B shows results of amplification using CG adaptors. A) Amplification of model DNA. Lines 1-6, amplification using increasing template amounts: 50, 100, 250, 500, 750 and 1000 ng degraded mouse DNA, respectively. Lines 7-10, control amplifications using no T4 polymerase during blunting (#7), no T4 ligase during ligation (#8), no T4 ligase during adapter ligation (#9), no template control for PCR (#10). B) Amplification of DNA isolated from plasma samples. Lines 1-8, amplification using plasma DNA samples. Lines 9-14, control amplification using re-ligated model DNA (#9)1, non re-ligated model DNA (#10)1, no T4 polymerase during blunting (#11), no T4 ligase during re-ligation (#12), no T4 ligase during adaptor ligation (#13), no template control for PCR (#14) Electrophoresis conditions were as detailed in FIG. 2.

FIGS. 4 A, B shows results of amplification using OJW adaptors. A) Amplification of model DNA. Lines 1-6, amplification using increasing template amounts: 10, 20, 50, 100, 250 and 500 ng degraded mouse DNA, respectively. Lines 7-11, control amplifications using genomic (intact) DNA (#7), 250 ng degraded human genomic DNA (#8), no T4 polymerase during blunting (#9), no T4 ligase during adapter ligation (#10), no template control for PCR (#11). B) Amplification of DNA isolated from plasma samples. Lines 1-4, amplification using plasma DNA samples. Lines 9-10, control amplifications using a 1:5 mixture of degraded and genomic (intact) human DNA (#5), degraded mouse DNA (#6), genomic (intact) human DNA (#7), no T4 polymerase during blunting (#8), no T4 ligase during adaptor ligation (#9), no template control for PCR (#10) Electrophoresis conditions were as detailed in FIG. 2.

FIGS. 5 A, B shows results of OJW-adaptor mediated amplification optimization. PCR amplification using OJW adaptors and plasma DNA samples gave higher yields with the improved protocol (19.5 U Taq Polymerase) (B) when compared to the original protocol (6.5 U Taq Polymerase) (A). Lines 1-2, amplification using plasma DNA samples. Line 3-7, control amplifications using a degraded mouse DNA (#3), genomic (intact) human DNA (#4), no T4 polymerase during blunting (#5), no T4 ligase during adaptor ligation (#6), no template control for PCR (#7) Electrophoresis conditions were as detailed in FIG. 2.

FIG. 6 shows results of differentially methylated regions detected by comparing plasma cell-free circulating DNA methylomes of prostate cancer patients and non-affected individuals. Volcano plot showing the differences in methylation distribution in prostate cancer patients and non-affected individuals. Spots above the horizontal line identify regions showing significant differences after correction for multiple testing (False Discovery Rate, FDR). Data is presented as methylation differences (X-axis) and −log₂ FDR corrected p-values (Y-axis). Horizontal red line shows the significance cutoff (FDR corrected p-value <0.05; then −log, (FDR corrected p-value)>4.32).

FIG. 7 shows the results of the unsupervised clustering of microarray data produced by enriching the unmethylated and methylated fractions. Microarray data from the technical replicates of the unmethylation fraction (HYPO1-5, right arm) clustered together and distinctively from the technical replicates of the methylated fractions (HYPER1-5, left arm). Cluster dendogram was produced using the hclust function included in the stats package of the Bioconductor software.

FIG. 8 shows the intra- and inter-group variance in the unmethylated and methylated fractions. Inter-group variance is significantly higher than intra-group variance. Volcano plot showing the distribution of the differences between the unmethylated and methylated fractions. Methylation data for each spot in the microarray (n=12,434) was compared in technical replicates (n=5) for each group (black circles) and between technical replicates of the unmethylated fraction (n=5) (red circles). Black circles which do not overlap with red circles represent the spots where the variance between the unmethylated and methylated fractions (inter-group variation) is higher than the variance of replicates of the unmethylated fraction alone (intra-group variation). Analysis of the variance by F-test showed that differences were statistically significant (p=2.2 e-16).

### DETAILED DESCRIPTION

The following description is of a preferred embodiment.

Changes in DNA methylation profiles of tumors constitute an early event (19). As tumors develop, tumor cells undergo apoptosis, shedding their DNA into the bloodstream and body fluids in contact with the organs where the tumor is growing. Thus, circulating tumor DNA can be detected in the plasma fraction of blood samples as well as other body fluids of cancer patients [20]. Also, current research suggests that cell apoptosis and necrosis are common features also in other complex diseases, such as neurodegenerative diseases [21] and metabolic disorders [22]. Because DNA is fragmented during apoptosis [23], cell-free circulating DNA from diseased cells is expected to be shorter than genomic DNA.

The present invention provides a method for analyzing DNA methylation profiles of circulating cell-free DNA in plasma or other bodily fluids and for identifying novel biomarkers associated with disease. Generally, the method is based on the enrichment of cell-free circulating methylated or unmethylated DNA by enzymatic digestion using DNA-methylation-sensitive/insensitive restriction enzymes and adaptor-mediated amplification. The enriched fraction is then interrogated by hybridization to microarrays containing either high CpG density regions (CpG islands arrays) or full-genome coverage (tiling arrays). Alternatively, the enriched fraction can be interrogated by DNA sequencing technologies, such as “deep” sequencing and further mapping to the genome. Differentially methylated regions are selected by comparing the profiles using standard statistical tests.

An important aspect and advantage relating to the practice of the method of the present invention is that molecular lesions far precede morphological transformation of preneoplastic lesions. As early detection of genetic and epigenetic abnormalities in cell-free DNA liberated from cells, tissues and other biological samples is possible before the detection of cytological changes [24], the method as described herein can be used for early detection of such abnormalities in cell free-DNA.

Also, as noted above, the method of the present invention advantageously facilitates discovery of biomarkers associated with disease in a genome-wide fashion by comparing profiles from affected individuals with those from healthy counterparts. As DNA methylation profiles in several loci are measured in parallel, the method offers higher sensitivity and specificity values as compared to other technologies for detecting biomarkers that are based on single-locus analysis.

While methods have been developed for large-scale DNA methylation profiling, combining DNA methylation-sensitive restriction and microarray platforms including interrogation of the unmethylated fraction [25, 26], differential methylation hybridization (DMH) for interrogation of the methylated fraction [31, 32], methylation immunoprecipitation on a chip (MeDIP) [27], comprehensive high-throughput arrays for relative methylation (CHARM) [28], Hpall tiny fragment enrichment by ligation-mediated PCR (HELP) [29] and microarray analysis of DNA digested with the DNA-methylation-specific enzyme MrcBc [28], none of these methods is suitable for the study of circulating DNA in plasma and other body fluids. The method of the present invention overcomes these drawbacks.

According to the present invention, there is provided a method for analyzing DNA methylation profiles of cell-free DNA in body fluids comprising the steps of

a) obtaining a bodily fluid from a subject that comprises cell-free DNA;

b) amplifying a methylated fraction of DNA or an unmethylated fraction of DNA from said cell-free DNA to produce amplified, cell-free DNA that are between about 0.1-5 kbp in size;

c) labeling said amplified cell-free DNA to produce labeled amplified cell-free DNA;

d) amplifying a corresponding methylated fraction of DNA or an unmethylated fraction of DNA from a pooled DNA sample of healthy subjects, said pooled DNA sample comprising DNA which are between about 0.1-5 kbp in size to produce an amplified, pooled sample of DNA;

e) labeling said amplified, pooled sample of DNA thereby producing labeled, amplified, pooled DNA;

f) hybridizing the labeled amplified cell-free DNA and the labeled amplified pooled sample of DNA to a microarray platform containing multiple synthetic DNA oligos representing the human genome, according to the following schemes:
I) if the array platform enables only single-color hybridizations, each labeled amplified cell-free DNA or pooled DNA samples are hybridized separately to individual microarrays.
II) if the array platform enables two-colors hybridizations, combining amplified cell-free DNA, which has been labeled with a first label, with amplified pooled DNA that has been labeled with a second label which is different from said first label and hybridizing the combined sample to a single microarray.

g) subjecting the microarrays to analysis to detect DNA methylation profiles of cell-free DNA.

The method of the present invention as described herein can also be employed for amplifying methylated and/or unmethylated cell-free DNA in bodily fluids, such as, but not limited to blood plasma and the like.

Since circulating tumor DNA fraction represents only a tiny part of the total DNA that can be isolated from plasma samples, circulating DNA released from non-tumor cells could therefore mask the results from circulating tumor DNA, especially DNA from white blood cells, which may contaminate samples during blood processing and/or plasma fraction separation. Thus, methylation profiles obtained from total plasma DNA should be compared against those obtained from white blood cells in order to filter out the loci with equivalent DNA methylation values in both samples.

The method of the present invention employs novel methodology including, but not limited to, the use of a new blood reference pool for microarray data normalization of DNA methylation profiles in circulating tumor DNA. The reference pool enables the comparison of signals from several microarrays to detect statistically significant differences. This is thought to represent a novel feature not previously employed in previous epigenetic studies. Alternatively, DNA methylation profiles elaborated from total plasma DNA can be directly compared to those elaborated from white blood cell DNA.

By using a reference pool made of small DNA fragments isolated from whole blood, and by amplifying short fragments of DNA in serum or other bodily fluids, the method of the present invention advantageously reduces the influence of this putative contamination by filtering out fragments whose methylation coincide in tumor DNA and DNA of peripheral blood leukocytes.

In an embodiment of the present invention, but without wishing to be limiting in any manner, the blood reference pool employed in the Examples comprised 20 different genomic DNA samples isolated from whole blood of healthy individuals. We have used a pool of 20 individuals consisting of 7 male and 13 female healthy individuals. 15 individuals were Caucasian, 2 Hispanic/Latino, 1 African American, 1 South Asian (Pakistan) and 1 North East Asian (China). The age range was 21-72 (average 35.25) years. The individuals in the reference pool were not related to subjects in the experiment. Also, the individuals in the blood reference pool were of different genders, ethnicities and ages. Thus, their methylation profiles represent those from a generally healthy population.

In an embodiment of the present invention, the first subject that comprises cell-free DNA may be diagnosed or suspected of having a disease such as a tumor, cancer or the like. More preferably, the tumor or cancer releases cell-free DNA in the subject's bodily fluids, for example, but not limited to blood. Conversely, the healthy individuals should be free of the corresponding disease, tumor, cancer or the like. Healthy individuals may be confirmed by screening using one or more acceptable tests as would be known in the art, for example by a physician or other appropriate person.

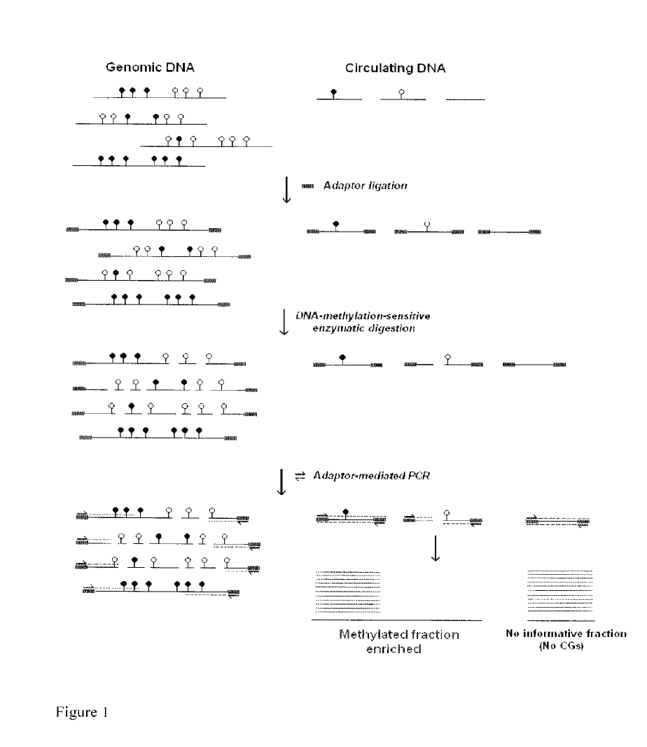

FIG. 1 schematically describes aspects of a preferred embodiment of the method of the present invention, but does not include method steps outlining the isolation of circulating DNA and use of blood reference pool for DNA microarray normalization. These aspects are included in the inventive method of the present invention.

In a preferred embodiment, DNA isolated from the plasma fraction or bodily fluids is blunted by incubating with T4 DNA polymerase. Specially designed short DNA sequences (“adaptors”) are linked to the blunted DNA by incubation with T4 ligase. Various adaptors may be employed. Next, adaptor-ligated DNA is digested with a mix of DNA-methylation-sensitive restriction enzymes for the enrichment of the methylated fraction. In the embodiment shown in FIG. 1, these enzymes will cut unmethylated CpG positions, while leaving methylated CpG positions uncut. Alternatively, to enrich the unmethylated fraction, adaptor-ligated DNA is digested with a mix of DNA-methylation-targeted enzymes. These enzymes will cut only when the cytosine is methylated (meCpG). Digested DNA is then amplified by PCR using primers specially designed to bind to the adaptors. Therefore, fragments containing methylated or unmethylated CG sites are preferentially amplified according to the type of enzymes used in the digestion step.

The method of the present invention employs specific PCR conditions for the amplification of short DNA stretches. Thus, PCR products are obtained only from undigested short templates that have attached adaptors at both sides (mainly from circulating DNA). In longer templates (as expected from genomic DNA), the DNA polymerase cannot extend primers in the distance between 5′ and 3′ adaptors and therefore, they will not be amplified. Overall, this represents a novel strategy for enriching the fraction derived from circulating DNA in the presence of high amounts of genomic DNA, for example, derived from nucleated cells such as white blood cells.

In a preferred embodiment, PCR is performed using amino-allyl labeled dNTPs that enable indirect fluorescent labeling (i.e. by Cy3/Cy5 dyes) before hybridization. Alternatively, PCR amplicons may be generated to contain amino-allyl labeled dNTPs that eventually are fragmented with a combination of uracil DNA glycosylase (UDG) and apurinic/apyrimidinic endonuclease 1 (APE 1). Following fragmentation, the resulting fragmented DNA can then be labeled using terminal deoxynucleotidyl transferase (TdT). Fragmentation and labeling reagents are included in WT Terminal Labeling Kit from Affymetrix (Santa Clara, Calif., USA). Labeled amplicons are then hybridized to the microarray using standard protocol, and DNA methylation profiles established using computational algorithms.

The method of the present invention may be employed to examine the methylation profiles of cell-free or free floating DNA in biological samples such as, but not limited to blood, lymph, urine, sputum, cerebral spinal fluid or the like that may (or may not) be contaminated with genomic DNA or cells comprising genomic DNA. It is to be understood that cell-free DNA may be obtained from samples that also comprise cells such as blood. A bodily fluid may be obtained from a subject by any route known in the art. In a preferred embodiment, which is not meant to be limiting, the bodily fluid is blood plasma from a human subject.

The present invention will be further illustrated in the following examples.

### EXAMPLES

### Example 1

### A Method for Large-Scale DNA Methylation Profiling in Cell-Free Circulating DNA in Plasma and Other Bodily Fluids

Method 1: Plasma Fraction Separation from Whole Blood Samples and DNA Extraction

Total DNA from the plasma fraction of whole blood samples was isolated. This protocol combines removal of contaminating proteins and other debris by phenol-chloroform extraction with the high DNA recovery provided by a silica membrane-based separation method. The detailed protocol is as follows:

1) 5 ml of peripheral blood was collected in BD Vacutainer CPT with sodium citrate as anticoagulant (Becton Dickinson). Blood samples were kept at room temperature until plasma separation for no more than 1 day.

2) Whole blood samples were centrifuged at 1,800 rpm for 20 min. After centrifugation the layers are separated: an upper (yellow), an intermediate (white) and a lower (red) layers containing the plasma, white cells and red cells, respectively.

3) The upper layer was removed with a pipette and collected in a new 15 ml falcon tube.

4) Plasma samples were stored at −80° C. until DNA isolation.

5) 1 ml of Lysis Buffer (see preparation below) and 30 μl Proteinase K (20 mg/ml) were added to 1 ml plasma. Samples were incubated overnight at 56° C. and 1,400 rpm agitation in a thermoshaker.

6) Lysates were divided into 1 ml aliquots in 2 ml tubes. 1 ml of pre-made 25:24:1 Phenol (pH=8): chloroform:isoamylalcohol mix (Sigma) was added to each aliquot. Mixes were incubated in a rotator at room temperature for 15 min.

7) Aqueous and organic phases were separated by centrifugation at 14,000 rpm for 5 min. Supernatants (aqueous phase) were separated in clean and labeled 1.5 ml tubes.

8) 1 ml 24:1 (v/v) chloroform:isoamyl alcohol mix was added to each supernatant. Tubes were incubated in rotator at room temperature for 15 min. Aqueous and organic phases were separated again by centrifugation at 14,000 rpm for 5 min. Supernatants (aqueous phase) were separated in clean and labeled 1.5 ml tubes.

9) Supernatants were divided in 500 μl aliquots. 500 μl of Sigma Lysis Buffer (included in the kit mentioned below) and 500 μl of 100% Ethanol were added to each aliquot. Samples were mixed by vortexing and spun down for 30 seconds at 6,500 rpm.

10) 500 μl of Column Preparation Solution was added to the pre-assembled column (the column and the solution are provided with the kit). Columns were centrifuged at 14,000 rpm for 1 min and flow-through liquid discarded.

11) The lysates from step 9 were added to the treated columns. Columns were centrifuged at 8,000 rpm for 1 min and the flow-through liquid discarded. This step was repeated as many times as required for loading all the aliquots of a plasma sample to the same column.

12) 500 μl of Wash Solution (included in the kit mentioned below) was added to the column. Columns were centrifuged at 8,000 rpm for 1 min and the flow-through liquid discarded.

13) Another 500 μl of Wash Solution was added to the column. Columns were centrifuged at 8,000 rpm for 3 min and the flow-through liquid discarded.

14) Columns were centrifuged again at 14,000 rpm for 5 min to evaporate any traces of ethanol and placed in new collection tubes.

15) DNA was eluted by adding 100 μl of PCR-grade water (pre-warmed at 55° C.) and incubation at 55° C. and 300 rpm agitation in thermoshaker. Columns were centrifuged at 8,000 rpm for 1 min. This elution step was repeated one more time.

16) DNA samples were concentrated to 100 μl final volume using speedvac and stored at −20° C. until use in target preparation protocol.

Materials

BD Vacutainer CPT. Cell preparation tubes with Citrate (Becton Dickinson).

GenElute mammalian genomic DNA miniprep kit (Sigma Aldrich).

Lysis buffer for genomic DNA isolation:

Stock Solutions:

Solution A (10×): 250 mM EDTA; 750 mM NaCl

Solution B (10×): 100 mM EDTA; 100 mM Tris-HCl (pH 8.0); 10% SDS

Working Solutions:

1 vol Solution A (10×)

1 vol Solution B (10×)

8 vol distillated water

Method 2: Target Preparation

The goal of this particular method, without wishing to be limiting, is the enrichment of the methylated fraction of the cell-free circulating DNA in plasma enabling the hybridization to microarrays. The detailed protocol is as follows:

1) Adaptor Ligation

1.1) Adaptor Annealing

Oligonucleotide sequences:

| | | |
|---|---|---|
| oJW102 | GCGGTGACCCGGGAGATCTGAATTC | (SEQ ID NO: 3) |
| oJW103 | GAATTCAGATC | (SEQ ID NO: 4) |

1) Oligonucleotides were dissolved in PCR-grade H₂0 to 40 μM.

2) 375 μl of each 40 μM oligonucleotide solution were mixed with 250 μl 1M Tris (pH: 7.9) to a 1,000 μl final volume and distributed in 100 μl aliquots in PCR tubes.

3) The incubation conditions were: 95° C. for 5 min, then at 70° C. for 2 min and 25° C. for 2 min and overnight at 4° C.

4) Once incubation was finished, aliquots were re-pooled.

5) The adaptor size was verified by electrophoresis in a 2% agarose gel. 3 μl of adapter/primer were loaded. Adaptors should show a single band of molecular weight (around 50 bp) that is higher than primers.

6) Annealed adaptors were stored at −20° C. until they were used in the adaptor ligation step. Various adaptors could be employed to carry out the method as described herein.

1.2) Blunting Ends

1) Blunting reaction conditions were: 50 μl of total plasma DNA (from Method 1), 1×T4 DNA ligase buffer (New England Biolabs), 100 μM dNTPs (Fermentas), 2 ng BSA (New England Biolabs) and 60 U T4 DNA polymerase (New England Biolabs) in 112.2 μl final volume.

2) Blunting reactions were incubated at 12° C. for 20 min and then placed on ice.

3) 11 μl of 3 M NaOAC and 2 μl of 20 mg/ml Glycogen were added to the blunting reactions and mixed thoroughly by vortexing.

4) 120 μl of pre-made phenol:chloroform:isoamyl alcohol (25:24:1) mix (Sigma) were added to blunting reactions. Samples were mixed for 1 min. Aqueous and organic phases were separated by centrifugation at 14,000 rpm for 1 min. Supernatants (aqueous phase) were separated in clean and labeled 1.5 ml tubes.

5) 230 μl of cold 100% ethanol were added to the supernatants and mixed by vortexing. Samples were incubated at −80° C. for 60 min. Once incubation was finished, samples were centrifuged for 30 min at 14,000 rpm at 4° C. A white pellet was observed attached at the bottom of the tube.

6) Supernatants were discarded and pellets were washed with 500 μl cold 70% ethanol. Next, samples were centrifuged for 5 min at 14,000 rpm at 4° C.

7) Supernatants were discarded and pellets were dried in speedvac until ethanol traces were completely evaporated.

8) Pellets were dissolved in 25 μl PCR grade H₂O and placed on ice until its use in the next step.

1.3) Adaptor Ligation

1) Adaptor ligation reactions were: 25 μl of end-blunt total plasma DNA, 1×T4 ligase buffer (New England Biolabs), 0.1 pmol annealed adaptor from step 1.1 and 5 U T4 DNA ligase (New England Biolabs) in a 50.2 μl volume.

2) Adaptor ligation reactions were incubated overnight at 16° C.

3) Once the incubation was finished, the DNA-methylation-sensitive enzymatic digestion step was performed immediately.

2.1) DNA-Methylation-Sensitive Enzymatic Digestion for the Enrichment of the Methylated Fraction

1) Digestion reaction conditions were: 50 μl of adaptor-ligated total plasma DNA, 1×NEB buffer 1, 10 U Hpall, 10 U HpyCH4IV and 10 U HinP1 (buffer and enzymes were acquired from New England Biolabs) in 56 μl final volume.

2) Reactions were incubated 8 hours at 37° C. After incubation was over, enzymes were deactivated by heating to 65° C. for 20 min. Tubes were kept at 4° C. until they were used in the next step.

2.2) DNA-Methylation-Targeted Enzymatic Digestion for the Enrichment of the Unmethylated Fraction

1) The adaptor ligation products were separated in three equivalent aliquots (16.6 μl each). Each aliquot was treated with one of the following conditions:

2) McrBc digestion. Reaction conditions were: 16.6 μl of adaptor-ligated total plasma DNA, 1×NEB buffer 2, 1×BSA, 1 mM GTP, 10 U McrBC (enzyme and reagents were acquired from New England Biolabs) in 25 μl final volume. Reaction were incubated 8 hours at 37° C. After incubation was over, the enzymes was deactivated by heating to 65° C. for 20 minutes. Tubes were kept at 4° C. until they were used in the next step.

3) GlaI digestion. Reaction conditions were: 16.6 μl of adaptor-ligated total plasma DNA, 1×SEB buffer GlaI 2, 10 U GlaI (enzyme and reagents were acquired from SybEnzymes) in 25 μl final volume. Reactions were incubated 8 hours at 30° C. After incubation was over, the enzymes were deactivated by heating to 65° C. for 20 minutes. Tubes were kept at 4° C. until they were used in the next step.

4) BlsI digestion. Reaction conditions were: 16.6 μl of adaptor-ligated total plasma DNA, 1×SEB buffer W, 10 U BlsI (enzyme and reagents were acquired from SybEnzymes) in 25 μl final volume. Reactions were incubated 8 hours at 30° C. After incubation was over, the enzymes were deactivated by heating to 65° C. for 20 minutes. Tubes were kept at 4° C. until they were used in the next step.

5) Products of the three digestions were pooled to the single tube and purified using MinElute Columns (Qiagen) according to manufacturer's instructions. DNA was eluted twice to the same tube using 25 μl water each time. Final volume was 50 μl.

3) Adaptor-Mediated PCR

1) Amplification reactions were as follows: 25 μl of digested template (from step 2), 1×PCR buffer (Sigma), 2.875 mM MgCl₂ (Sigma), 1.6 μl oJW102 primer, 0.275 mM of a mix containing Aminoallyl dNTPs and 19.5 U Taq polymerase (New England Biolabs) in 100 μl final volume. (Allyl dNTP mix: in one tube allyl-dUTP (50 μl 50 μM, Ambion) were added: 16.5 μl H₂O, 16.6 μl dTTP, 41.6 μl dGTP, 41.6 μl dCTP and 41.6 μl dATP (all dNTPs were from Fermentas).

2) Amplification conditions were: 72° C. for 5 min (initial activation), 24 cycles of 95° C. for 1 min, 93° C. for 40 seconds and 67° C. for 2:30 min, and 72° C. for 5 min (final elongation).

3) PCR products were verified by agarose electrophoresis. 10 μl of PCR product was run in a 1% agarose gel for 40 min at 100 V. Expected PCR products are smears ranging from about 400 to about 1,500 bp. Bands can be seen within the smears.

4) PCR Product Purification and Quantification

1) Products from two independent amplifications per sample were pooled.

2) Pools were purified using the MinElute PCR Purification Kit (Qiagen) according to manufacturer's instruction. DNA was eluted in 10 μl PCR-grade water pre-warmed at 55° C.

3) The concentration of the purified PCR products was assessed using Nanodrop.

Method 3: Microarray Preparation and Hybridization

This method follows the standard practices in our lab with minor changes. The protocol was developed for the target hybridization to two-colors CpG island arrays (UHN Microarray Facility, Toronto).

1.1. Target and Blood Reference Pool Concentration

1) Equal amounts (usually 1.5-2 μg) of the methylated DNA-enriched fraction from the test samples and the blood reference pool prepared following the protocols mentioned above were aliquoted separately in 1.5 ml tubes and completely evaporated using speedvac.

2) 3 μl of DMSO (Sigma) and 9 μl of 0.1 M pH=9 Sodium Bicarbonate were added to each tube.

3) Tubes were stored at −20° C. until they were used in the labeling step.

1.2) Fluorescent Dye Labeling

1) Individual tubes containing the methylated DNA-enriched fractions were heated for 2 min at 100° C. 4.5 μl of dye (Cy5 and Cy3, GE Life Sciences) were added to each tube, with amplified cell-free DNA receiving one colour (eg. Cy3, appears red) and the blood reference pool receiving another (eg. Cy5, appears blue).

2) Tubes were centrifuged for 1 minute and then transferred to a buoyant rack. Tubes were incubated in a water bath at 30° C. for 2 hours

3) After incubation, dyes were quenched by adding 4.5 μl of 4M hydroxylamine. Tubes were incubated for 15 min protected from light.

4) 294 μl of column binding solution (3 μl 3M Sodium Acetate, 275 μl Qiagen PB Binding Buffer and 16 μl H₂O) was added to the labeled targets. Next, labeled amplified cell-free DNA (targets) and labeled, amplified, pooled DNA were combined (solutions turn violet).

5) Mixes of target and blood reference pool were loaded to MinElute columns (Qiagen) and DNA was purified according to manufacturer's indications. The samples were eluted twice with 25 μl of PCR-grade H₂O.

6) After purification samples were evaporated in a speedvac (protected from light). Once samples were evaporated, hybridization to the array was performed.

1.3. Array Hybridization

1) The methylated fractions from circulating cell free DNA and blood reference pool that have been previously evaporated mixed and labeled were dissolved 100 μl of Slide Hyb #2 solution (Ambion), 5 μl t-RNA (10 mg/ml, Sigma) and 5 μl calf thymus DNA (10 mg/ml, Bioshop)

2) Mixes were incubated at 72° C. for 5 min. Next, samples were distributed on the surface of a CpG island array (UHN, Toronto) placed on a hybridization chamber (Corning). Coverslips were applied to the arrays and the hybridization chamber was hermetically closed.

3) Hybridization chambers were incubated in a water bath at 47° C. overnight.

1.4. Array Washing and Scanning

1) After incubation, arrays were placed in swish jar containing Washing Buffer (3×SCC, 1% SDS) and incubated at 47° C. for 15 min.

2) Arrays were then transferred to a new swish jar containing fresh Washing Buffer and incubated at 47° C. for 15 min. This washing step was repeated one additional time.

3) After the third wash, arrays were dipped briefly (1-2 sec) in 1×SCC solution and then in 0.1×SCC. Arrays were dried by centrifugation and kept protected from light until scanning.

4) Arrays were scanned using an Axon 4000A scanner. Results were managed using the GenPix Pro 6.0 software.

Method 4: Data Analysis

Microarray data was cross-referenced to annotated GAL files using Genepix 6.0 Software. Microarray GAL annotation was made available from the manufacturer and downloaded at www.microarrays.ca.

Normalization procedures were carried out in Bioconductor using the Limma package. All arrays underwent log ratio-based normalization, background correction, and print tip loess normalization. Log fold change values (M values) represent the ratio of the normalized amplified, pooled DNA (from blood reference pool) labelled with Cy5 over the sample value obtained for amplified cell-free DNA labelled with Cy3 (M=Log(Cy5/Cy3).

Low quality flagged loci identified by Genepix were removed. Microarray data was trimmed based on the annotation information such that spot 1Ds containing mitochondrial DNA, translocation hot spots and repetitive elements were removed such that only unique DNA sequences in humans were used for subsequent statistical analyses.

All statistical tests were performed in R (http://www.r-project.org/). For all comparisons, an unpaired t-test was performed between the affected vs. control groups. Correction for multiple testing was performed according to the FDR method using the qvalue package in R. Statistically significant loci below a threshold of occurring at 5% by chance after correction were selected for follow up analysis and validation.

Results

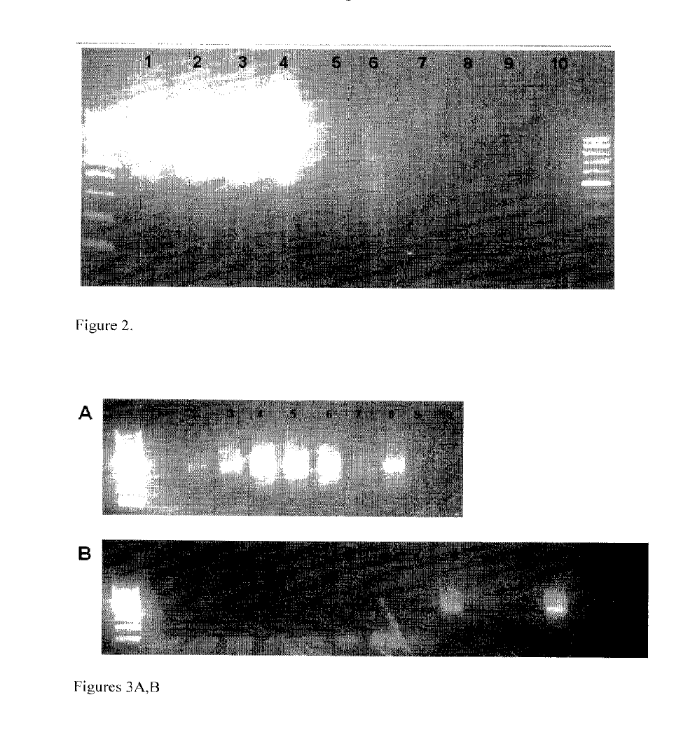

FIG. 2 shows the preferential amplification of plasma DNA when using the method as described herein. Lines 1 to 4 are the amplification products from actual DNA samples isolated from the plasma fraction. In contrast, there is no amplification when intact genomic DNA is processed (line 7). It is worth nothing that there was no amplification also in a 1:5 degraded-intact DNA mix of human DNA (line 5) and less amplification product in artificially degraded DNA (line 6). These results suggest that the method as described herein preferentially amplifies small DNA fragments and it is able to amplify cell-free circulating DNA present in the total DNA isolated from the plasma sample, even in the presence of contaminating genomic DNA. The combination of the preferential amplification of relatively short fragments plus the use of a blood reference pool to filter out regions of equivalent methylation, drastically minimize the impact of genomic DNA contamination in the total plasma DNA.

1.1. Use of Specific Adaptors Enabled Amplification of DNA Isolated from Plasma Samples

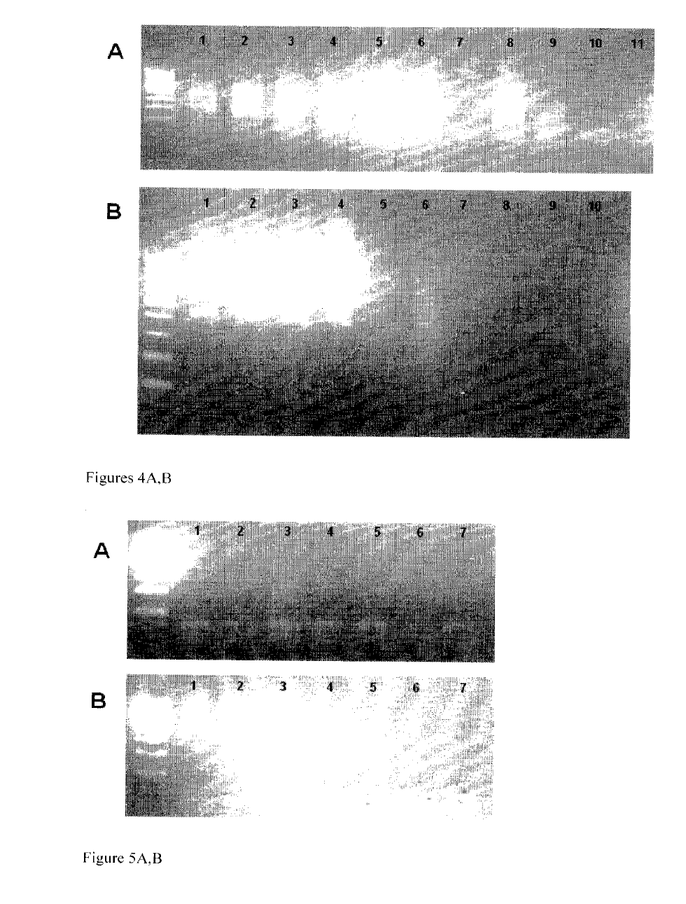

A previous protocol developed in our lab (Schumacher, A., et al., Microarray-based DNA methylation profiling: technology and applications. Nucleic Acids Res, 2006. 34(2): p. 528-42), using the following adaptors (CGIb: AGTTACATCTGGTAGTCAGTCTCCA (SEQ ID NO:1); CGIa: CGTGGAGACTGACTACCAGAT (SEQ ID NO:2)) resulted in relatively poor amplification results. Experiments using this adaptor showed positive amplification of several amounts of model DNA (degraded mouse DNA) after adaptor ligation and PCR (FIG. 3A). However, little amplification could be seen when using DNA isolated from plasma samples (FIG. 3B).

To overcome this lack of amplification, the adaptor to the OJW adaptor known in the art. Using this adaptor, we were able to amplify successfully up to 10 ng model DNA (FIG. 4A) and to amplify successfully DNA isolated from plasma samples (FIG. 4B). Other adaptors also enabled sufficient amplification and analysis of DNA methylation profiles.

For this experiment, total DNA from the plasma fraction was isolated following Method 1 described previously. The control DNAs were:

i. Naturally degraded genomic DNA isolated from mouse liver: degradation was confirmed by agarose electrophoresis.

ii. Intact genomic DNA isolated from human PBL: integrity was confirmed by agarose electrophoresis.

iii. Artificially degraded genomic DNA (from ii.): DNA was sonicated (Branson sonicator, 80% cycle, 10 sec, level 3, 3 times). Degradation was confirmed by agarose electrophoresis.

Amplification using CG adaptors was performed following the original protocol by Schumacher et al as recited herein. Amplification using the OJW adaptors was performed following the protocol detailed in Method 2 described previously.

1.2. Addition of Blunting Step Increased Reaction Yield

The inclusion of a blunting step resulted in high amplification yields (FIG. 4B, lines 1-4). In contrast, there was no amplification without the blunting step (FIG. 4B, line 8; control reaction without T4 polymerase enzyme during blunting step).

For this experiment, total plasma DNA and control DNAs were prepared as detailed in 4.1. Target preparation was followed as detailed in Method 2 for both plasma and control DNAs. Specifically, in the control reaction without T4 polymerase, all the components of the blunting reaction were included but PCR-grade H₂O was included instead of the enzyme.

1.3. Ligation Reaction Conditions to Reduce Sample Loss

The products of the blunting and adaptor ligation reactions are the template for the final amplification reaction. After the blunting step is finished, the T4 polymerase enzyme should be removed by a round of DNA purification. Since the amount of DNA isolated from plasma sample is minimal, the DNA recovery after purification should be maximized. In this regard, all the successive reactions should be performed in the same tube.

The addition of glycogen is used to reduce DNA loss during the successive purification steps by phenol/chloroform extraction and ethanol precipitation. Glycogen does not interfere with the downstream reactions. Differently to any of the protocols mentioned above, our protocol contains only one intermediate DNA purification step. In addition, the reaction volumes in the blunting and adaptor ligation reactions are low, avoiding concentration steps that may result in DNA loss and enabling us to perform successive reactions to be performed within the same tube.

1.4. Amplification for Enrichment of Short Fragments

This amplification method yields fragments in the size range expected for circulating DNA fragments (400-1,500 bp). Nevertheless, by applying the amplification method to the OJW-adaptor-ligated plasma DNA as described in the original publication we did not obtain enough PCR product amount for microarray hybridization with plasma DNA samples. Without wishing to be limiting or bound by theory, this was probably due to low template amount and different PCR efficiency as adaptor ligation and DNA methylation-sensitive digestion protocols were modified. Therefore, we obtained an enhancement of the amplification conditions by increasing the Taq polymerase amount 3-fold (FIG. 5).

For this experiment, total plasma DNA and control DNAs were prepared as detailed in 4.1. Target preparation was followed as detailed in Method 2 for both plasma and control DNAs until the adaptor-mediated amplification step. 25 μl of each digested template was used as template in the amplification reaction containing 6.5 U and 19.5 U of Taq polymerase (FIGS. 5A and B, respectively). Amplifications were performed unchanged for both conditions.

### Example 2

### Identification of Differentially Epigenetically Modified DNA in Circulating Plasma of Subjects with Prostate Cancer or Benign Prostate Hypertrophy and Validation of Markers

In this study, we determined genome-wide DNA methylation profiles in circulating DNA of 20 Prostate Cancer patients, 20 Benign Prostate Hyperplasia patients and 20 non-affected individuals. All subjects were Caucasian males, older than 50 years. Prostate Cancer patients had T2N×MO prostate cancer. Benign Prostate Hyperplasia group was selected using pathology reports. This study demonstrated that the method of the present invention enables large scale cell-free DNA methylation profile analysis (methylome analysis) in plasma samples from cancer patients.

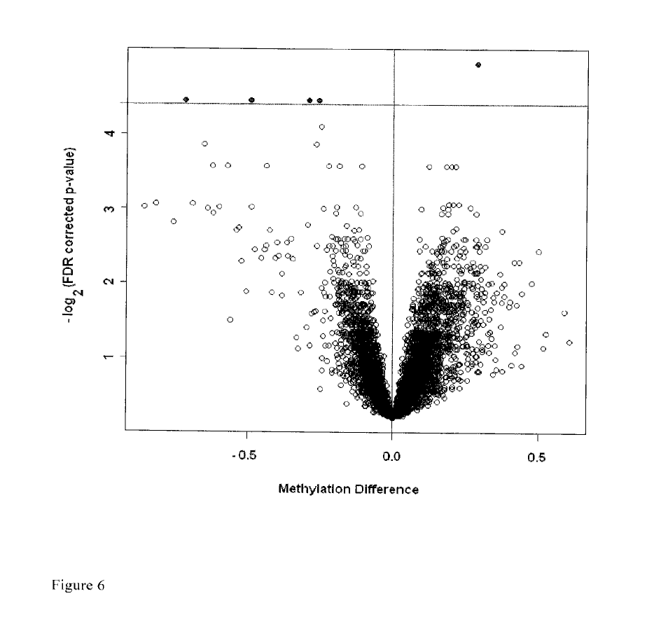

In a preliminary data analysis, we compared the methylomes in Prostate Cancer patients against those in healthy individuals. Five regions showed significant differential methylation after multiple testing correction (FIG. 6 (see points above horizontal line 3.0 on Y-axis). Out of these five regions, 3 were methylated in Prostate Cancer patients and corresponded to annotated genes (TFG, ATOH8 and SIX3), while 2 were unmethylated in Prostate Cancer patients and corresponded to CpG dense regions with multiple hits in the genome (Table 1).

TABLE 1
Differentially methylated regions in plasma circulating DNA in
prostate cancer patients compared to non-affected individuals

| Gene Symbol/ | | Methylation in |
|---|---|---|
| Region | Gene Name | Prostate Cancer |
| TFG | TRK-fused gene | Methylated |
| ATOH8 | atonal homolog 8 | Methylated |
| SIX3 | Homeobox protein SIX3 | Methylated |
| UHNhscpg 0002099 | Not annotated | Methylated |
| UHNhscpg 0011690 | Not annotated | Unmethylated |

Next, we compared the methylomes of Prostate Cancer patients against those of Benign Prostate Hyperplasia patients and non-affected individuals taken together. We found differential methylation at the regulatory region of many annotated genes and selected 185 loci showing the highest methylation differences for further analysis. Table 2 shows as an example five novel differentially methylated genes identified practicing the method of the present invention.

TABLE 2
Examples of novel differentially methylated genes in prostate
cancer patients compared to patients with Benign Prostatic
Hypertrophy and non-affected individuals

| Gene | | Methylation in |
|---|---|---|
| Symbol | Gene Name | Prostate Cancer |
| CBFA2T2 | core-binding factor, runt domain, | Methylated |
| | alpha subunit 2; translocated to, 2 | |
| RNF157 | ring finger protein 157 | Methylated |
| TCF4 | transcription factor 4 | Methylated |
| ZC3H4 | zinc finger CCCH-type containing 4 | Unmethylated |
| CHP2 | calcineurin B homologous protein 2 | Unmethylated |
| ESD | esterase D/formylglutathione hydrolase | Unmethylated |

Furthermore, we found that methylomes in plasma circulating DNA of prostate cancer patients and benign prostatic hypertrophy patients were similar, without regions showing significant differential methylation after correction for multiple testing. These results suggest that epigenetic phenomena might play a role in the establishment of the both cellular phenotypes. Table 3 shows as an example five novel loci showing the highest methylation differences between Prostate Cancer and Benign Prostate Hyperplasia identified practicing the method of the present invention.

TABLE 3
Examples of novel differentially methylated genes in prostate cancer
patients compared to patients with Benign Prostatic Hypertrophy

| Gene | | Methylation in |
|---|---|---|
| Symbol | Gene Name | Prostate Cancer |
| ASCC3L1 | activating signal cointegrator 1 complex | Unmethylated |
| | subunit | |
| FBXL10 | F-box and leucine-rich repeat protein 10 | Methylated |
| | isoform | |
| NEIL2 | NEIL2 protein | Methylated |
| NUP93 | nucleoporin 93 kDa | Methylated |
| CDON | surface glycoprotein, Ig superfamily member | Unmethylated |

The methods as described herein enable the discovery and validation of novel biomarkers for non-invasive screening procedures. Also, it allows one of skill in the art determine the relationship of epigenetic changes to specific environmental and dietary exposures, SNP genotypes and cancer phenotypes.

All citations are hereby incorporated by reference.

The present invention has been described with regard to one or more embodiments. However, it will be apparent to persons skilled in the art that a number of variations and modifications can be made without departing from the scope of the invention as defined in the claims.

### Example 3

### Comparison of DNA Methylation Profiles of Circulating Plasma DNA Obtained by Enriching the Methylated and Unmethylated Fractions from the Same Individual

In this study we compared the profiles obtained by enriching the methylated and unmethylated fractions from circulating DNA of the same individual. We have used five technical replicates per sample. As reference we used white blood cells DNA from the same individual from which we have isolated the plasma DNA.

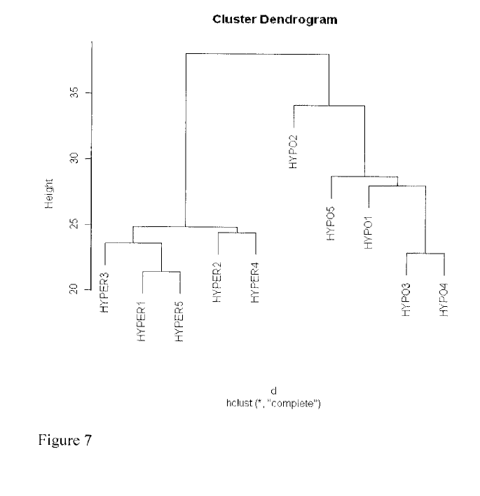

FIG. 7 shows the cluster dendogram produced by unsupervised hierarchical clustering of the microarray data from the technical replicates corresponding to the unmethylated and methylated fractions. Replicates from each group clustered together. Two distinct nodes were differentiated, one corresponding to the replicates of the unmethylated fractions (HYPO1-5, right arm) and another corresponding to the replicates of the methylated fractions (HYPER1-5, left arm). These results suggest that the fractions enriched using the enrichment protocol for the unmethylated fraction is different to those produced by using the protocol for the enrichment of the methylated fraction.

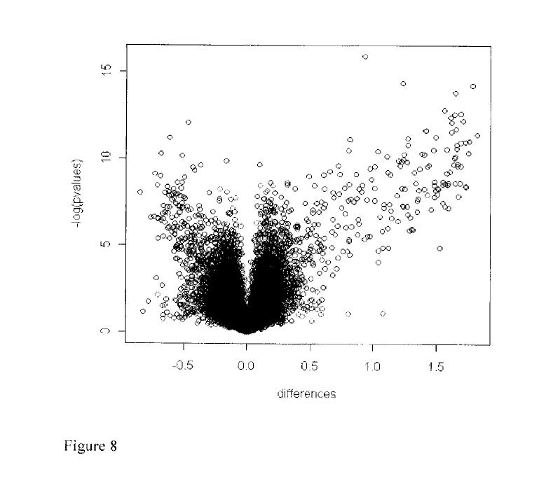

FIG. 8 shows the distribution of the intra- and intergroup variance in a volcano plot. The intragroup variance among replicates of the unmethylated fractions (red circles) was small, ranging between −0.5 and 0.5. Unlike, the intergroup variance between replicates of the unmethylated and methylated fractions (black circles) was more disperse. Two distinctive clouds of black circles can be differentiated at the left and right sides of the plot (variance higher than 0.5 in both directions). These points represent the spots where the intergroup is higher than the intragroup variance and therefore, the variance is due to the different methylation enrichment protocols and not to a technical artifact. To determine whether the differences in inter- and intragroup variances are statistically significant, we compared them using the F-test (including in the stats package of the Bioconductor software). We compared 12,434 spots in 5 technical replicates in each group. Intergroup variance was significantly higher than intragroup variance (F statistic=3.098, 95% CI: 2.991094-3.2089701, p-value<2.2e-16).

### REFERENCES

### References

1. Paz, M. F., et al., Germ-line variants in methyl-group metabolism genes and susceptibility to DNA methylation in normal tissues and human primary tumors. Cancer Res. 2002. 62(15): p. 4519-24.
2. Herman, J. G. and S. B. Baylin, Gene silencing in cancer in association with promoter hypermethylation. N Engl J Med, 2003. 349(21): p. 2042-54.
3. Eckhardt, F., et al., DNA methylation profiling of human chromosomes 6, 20 and 22. Nat Genet, 2006. 38(12): p. 1378-85.
4. Baylin, S. B. and J. G. Herman, DNA hypermethylation in tumorigenesis: epigenetics joins genetics. Trends Genet, 2000. 16(4): p. 168-74.
5. Esteller, M., Epigenetics in cancer. N Engl J Med, 2008. 358(11): p. 1148-59.
6. Markl, I. D., et al., Global and gene-specific epigenetic patterns in human bladder cancer genomes are relatively stable in vivo and in vitro over time. Cancer Res. 2001. 61(15): p. 5875-84.
7. Bremnes, R. M., R. Sirera, and C. Camps. Circulating tumour-derived DNA and RNA markers in blood: a tool for early detection, diagnostics, and follow-up? Lung Cancer. 2005. 49(1): p. 112.
8. Wong, I. H., Y. M. Lo, and P. J. Johnson, Epigenetic tumor markers in plasma and serum: biology and applications to molecular diagnosis and disease monitoring. Ann N Y Acad Sci, 2001.945: p. 36-50.
9. Stroun. M., et al., About the possible origin and mechanism of circulating DNA apoptosis and active DNA release. Clin Chim Acta. 2001. 313(1-2): p. 139-42.
10. Allen, D. et al., Role of cell free plasma DNA as a diagnostic marker, for prostate cancer. Ann N Y Acad Sci, 2004. 1022: p. 76-80.
11. Boddy, J. L., et al., Prospective study of quantitation of plasma DNA levels in the diagnosis of malignant versus benign prostate disease. Clin Cancer Res, 2005. 11(4): p. 1394-9.
12. Chun. F. K., et al., Circulating tumour-associated plasma DNA represents an independent and informative predictor of prostate cancer. BJU Int. 2006. 98(3): p. 544-8.
13. Evron, E., et al., Detection of breast cancer cells in ductal lavage fluid by methylation-specific PCR. Lancet, 2001. 357(9265): p. 1335-6.
14. Dong, S. M., et al., Detecting colorectal cancer in stool with the use of multiple genetic targets. J Natl Cancer Inst, 2001. 93(11): p. 858-65.
15. Palmisano, W. A., et al., Predicting lung cancer by detecting aberrant promoter methylation in sputum. Cancer Res, 2000. 60(21): p. 5954-8.
16. Goessl, C., et al., Fluorescent methylation-specific polymerase chain reaction for DNA-based detection of prostate cancer in bodily fluids. Cancer Res. 2000. 60(21): p. 5941-5.
17. Widschwendter. M. and P. A. Jones, The potential prognostic, predictive, and therapeutic values of DNA methylation in cancer. Commentary re: Kwong et al., Promoter hypermethylation of multiple genes in nasopharyngeal carcinoma. Clin. Cancer Res., 8: 131-137, 2002, and H-Z. Zou et al., Detection of aberrant p16 methylation in the serum of colorectal cancer patients. Clin. Cancer Res., 8: 188-191, 2002. Clin Cancer Res. 2002. 8(1): p. 17-21.
18. Fleischhacker, M. and B. Schmidt, Circulating nucleic acids (CNAs) and cancer—a survey. Biochim Biophys Acta. 2007. 1775(1): p. 181-232.
19. Esteller M. Epigenetics in cancer. N Engl J Med. 2008 Mar. 13; 358(11):1148-59.
20. Widschwendter M, Jones P A. The potential prognostic, predictive, and therapeutic values of DNA methylation in cancer. Clin Cancer Res. 2002 January; 8(1):17-21.
21. Kalinichenko S G, Matveeva N Y. Morphological characteristics of apoptosis and its significance in neurogenesis. Neurosci Behav Physiol. 2008 May; 38(4):333-44.
22. Malhi H, Gores G J, Lemasters J J. Apoptosis and necrosis in the liver: a tale of two deaths?Hepatology. 2006 February; 43(2 Suppl 1):S31-44.
23. Lichtenstein A V, Melkonyan H S, Tomei L D, Umansky S R. Circulating nucleic acids and apoptosis. Ann N Y Acad Sci. 2001 September; 945:239-49. Review.
24. Brambilla, C., et al., Early detection of lung cancer: role of biomarkers. Eur Respir J Suppl, 2003. 39: p. 36s-44s.
25. Schumacher A, Kapranov P. Kaminsky Z, Flanagan J. Assadzadeh A. Yau P, Virtanen C, Winegarden N, Cheng J, Gingeras T, Petronis A. Microarray-based DNA methylation profiling: technology and applications. Nucleic Acids Res. 2006 Jan. 20; 34(2):528-42.
26. WO 2005078121
27. Weber M, Davies J J, Wittig D, Oakeley E J, Haase M. Lam W L. Schübeler D. Chromosome-wide and promoter-specific analyses identify sites of differential DNA methylation in normal and transformed human cells. Nat Genet. 2005 August; 37(8):853-62.
28. Irizarry R A. Ladd-Acosta C. Carvalho B. Wu H, Brandenburg S A, Jeddeloh J A, Wen B, Feinberg A P. Comprehensive high-throughput arrays for relative methylation (CHARM). Genome Res. 2008 May; 18(5):780-90.
29. Khulan B, Thompson R F. Ye K, Fazzari M J, Suzuki M. Stasiek E. Figueroa M E, Glass J L, Chen Q, Montagna C, Hatchwell E. Selzer R R, Richmond T A, Green R D, Melnick A, Greally J M, Comparative isoschizomer profiling of cytosine methylation: the HELP assay. Genome Res. 2006 August; 16(8):1046-55.
30. Fleischhacker, M. and B. Schmidt, Circulating nucleic acids (CNAs) and cancer—a survey. Biochim Biophys Acta. 2007. 1775(1): p. 181-232.
31. Huang T H, Perry M R, Laux D E. Methylation profiling of CpG islands in human breast cancer cells. Hum Mol Genet. 1999 March; 8(3):459-70.
32. Lewin J. Plum A, Hildmann T, Rujan T, Eckhardt F, Liebenberg V. Lofton-Day C, Wasserkort R. Comparative DNA methylation analysis in normal and tumour tissues and in cancer cell lines using differential methylation hybridisation. Int J Biochem Cell Biol. 2007; 39(7-8):1539-50.

What is claimed is:

1. A method for analyzing large-scale DNA methylation profiles of cell-free DNA in bodily fluids comprising the steps of:
a) obtaining a body fluid from a subject that comprises cell-free DNA;
b) amplifying a methylated fraction of DNA or a unmethylated fraction of DNA from said cell-free DNA to produce amplified cell-free DNA that is between about 0.1-5 Kb in size;
c) labeling said amplified cell-free DNA with a first label to produce labeled amplified, cell-free DNA;
d) amplifying a DNA pool isolated from peripheral blood leukocytes from several healthy individuals and mechanically fragmented to 0.1-5 kbp in size to produce amplified, pooled DNA;
e) labeling said amplified, pooled DNA with a second label which is different from said first label to produce labeled, amplified, pooled DNA;
f) combining labeled, amplified, pooled DNA with labeled amplified cell-free DNA and subjecting the combined sample to microarray hybridization and analysis to analyze DNA methylation profiles in cell-free DNA.

2. The method of claim 1, wherein the body fluid is blood.

3. The method of claim 1, wherein the body fluid is plasma.

4. The method of claim 1 wherein the body fluid comprises cells and said method further comprises a step of separating cells from said cell-free DNA.

5. The method of claim 1, wherein the cell-free DNA comprises DNA from diseased cells or tissue.

6. The method of claim 5, wherein the diseased cells or tissue comprise cancer or tumor cells.

7. The method of claim 1, wherein the methylated fraction of cell-free DNA is amplified and said DNA is between 0.1-1.5 kbp in size.

8. The method of claim 1, wherein the first label is Cy3 and the second label is Cy 5 or vice-versa.

9. The method of claim 1, wherein the pooled DNA sample comprises pooled blood samples.

10. The method of claim 1, wherein the pooled DNA sample is sonicated to comprise DNA fragments between 0.1-5 kbp in size.

11. The method of claim 1, wherein the body fluid is blood and the pooled DNA sample comprises blood pooled from healthy subjects of varying ages, genders and ethnicities.

12. The method of claim 1, wherein the amplified cell-free DNA and the amplified, pooled sample of DNA are each between about 400 to 1,500 base pairs in size.


SEQUENCE LISTING (4 sequences)

SEQ ID NO: 1 - DNA, 25 bp, Artificial Sequence
  Adaptor CG1b
agttacatctggtagtcagtctcca

SEQ ID NO: 2 - DNA, 21 bp, Artificial Sequence
  Adaptor CG1a
cgtggagactgactaccagat

SEQ ID NO: 3 - protein, 25 aa, Artificial Sequence
  Adaptor oJW102
GCGGTGACCCGGGAGATCTGAATTC

SEQ ID NO: 4 - protein, 11 aa, Artificial Sequence
  Adaptor oJW103
GAATTCAGATC